(19) United States
(12) Patent Application Publication
(10) Pub. No.: US 2021/0374447 A1
(43) Pub. Date: Dec. 2, 2021

(54) METHOD AND DEVICE FOR PROCESSING IMAGE, ELECTRONIC EQUIPMENT, AND STORAGE MEDIUM

(71) Applicant: SHENZHEN SENSETIME TECHNOLOGY CO., LTD., Shenzhen (CN)

(72) Inventors: Yi LIU, Shenzhen (CN); Wenzhong JIANG, Shenzhen (CN); Hongbin ZHAO, Shenzhen (CN)

(21) Appl. No.: 17/395,597

(22) Filed: Aug. 6, 2021

Related U.S. Application Data
(63) Continuation of application No. PCT/CN2020/087784, filed on Apr. 29, 2020.

(30) Foreign Application Priority Data
Jun. 28, 2019 (CN) 201910575840.3

(51) Int. Cl. G06K 9/03; G06K 9/00; G06T 7/70; G06T 5/00; G06T 5/20

(52) U.S. Cl. CPC G06K 9/036; G06K 9/00288; G06T 5/20; G06K 9/00255; G06T 5/003; G06T 7/70

(57) ABSTRACT

Embodiments herein disclose a method and device for processing an image, electronic equipment, and a storage medium. The method is as follows. A face image frame sequence of which a first face parameter meets a preset condition is acquired by filtering an image frame sequence. A second face parameter of each face image in the face image frame sequence is determined. A quality score of the each face image in the face image frame sequence is determined according to the first face parameter and the second face parameter of the each face image in the face image frame sequence. A target face image for face recognition is acquired according to the quality score of the each face image in the face image frame sequence.

### CROSS-REFERENCE TO RELATED APPLICATIONS

This is a continuation application of International Patent Application No. PCT/CN2020/087784, filed on Apr. 29, 2020, which claims priority to Chinese Patent Application No. 201910575840.3, filed on Jun. 28, 2019. The entire contents of International Patent Application No. PCT/CN2020/087784 and International Patent Application No. PCT/CN2020/087784 are incorporated herein by reference in their entireties.

### BACKGROUND

With development of electronic technologies, face recognition technologies have been increasingly maturing and extensively applied to various scenes, such as application scenes of clock-in for attendance checking, face unlocking of a mobile phone, identity recognition of an electronic passport and network payment based on face recognition technologies, facilitating daily life.

At present, there may be some image frames with blurred faces or without face images in a collected image frame sequence, and face recognition over these image frames may waste lots of processing resources.

### SUMMARY

Embodiments herein provide a method and device for processing an image, electronic equipment, and a storage medium.

According to an aspect herein, a method for processing an image includes: acquiring, by filtering an image frame sequence, a face image frame sequence of which a first face parameter meets a preset condition; determining a second face parameter of each face image in the face image frame sequence; determining a quality score of the each face image in the face image frame sequence according to the first face parameter and the second face parameter of the each face image in the face image frame sequence; and acquiring a target face image for face recognition according to the quality score of the each face image in the face image frame sequence.

According to another aspect herein, electronic equipment includes memory and a processor. The memory is configured for storing instructions executable by the processor. The processor is configured for implementing a method for processing an image herein.

According to another aspect herein, a computer-readable storage medium has stored thereon computer program instructions which, when executed by a processor, implement a method for processing an image herein. Understandably, the general description above and the elaboration below are exemplary and explanatory only, and do not limit the subject disclosure.

Other characteristics and aspects herein may become clear according to detailed description of exemplary embodiments made below with reference to the drawings.

### BRIEF DESCRIPTION OF THE ACCOMPANYING DRAWINGS

Drawings here are incorporated in and constitute part of the subject disclosure, illustrate embodiments according to the subject disclosure, and together with the subject disclosure, serve to explain a technical solution of the subject disclosure.

FIG. 1 is a flowchart of a method for processing an image according to an embodiment herein.

FIG. 2 is a flowchart of determining a face image frame sequence according to an exemplary embodiment herein.

FIG. 3 is s a flowchart of processing an image according to an exemplary embodiment herein.

FIG. 4 is a block diagram of a device for processing an image according to an embodiment herein.

FIG. 5 is a block diagram of electronic equipment according to an exemplary embodiment herein.

### DETAILED DESCRIPTION

Exemplary embodiments, characteristics, and aspects herein are elaborated below with reference to the drawings. Same reference signs in the drawings may represent elements with the same or similar functions. Although various aspects herein are illustrated in the drawings, the drawings are not necessarily to scale unless expressly pointed out otherwise.

The dedicated word “exemplary” may refer to “as an example or an embodiment, or for descriptive purpose”. Any embodiment illustrated herein as being “exemplary” should not be construed as being preferred to or better than another embodiment.

A term “and/or” herein merely describes an association between associated objects, indicating three possible relationships. For example, by A and/or B, it may mean that there may be three cases, namely, existence of but A, existence of both A and B, or existence of but B. In addition, a term “at least one” herein means any one of multiple, or any combination of at least two of the multiple. For example, including at least one of A, B, and C may mean including any one or more elements selected from a set composed of A, B, and C.

Moreover, a great number of details are provided in embodiments below for a better understanding of the subject disclosure. A person having ordinary skill in the art may understand that the subject disclosure can be implemented without some details. In some embodiments, a method, means, an element, a circuit, etc., that is well-known to a person having ordinary skill in the art may not be elaborated in order to highlight the main point of the subject disclosure.

According to a solution for processing an image herein, a collected image frame sequence may be filtered, acquiring a face image frame sequence of which a first face parameter meets a preset condition. Accordingly, image frames in the image frame sequence may be filtered preliminarily through first face parameters, acquiring the face image frame sequence. Then, a second face parameter of each face image in the face image frame sequence is determined. A quality score of the each face image is acquired according to the first face parameter and the second face parameter of the each face image in the face image frame sequence. A target face image for face recognition is determined according to the quality score of the each face image. Accordingly, the image frame sequence may further be filtered, determining the target face image for face recognition. In this way, before face recognition, image frames in an image frame sequence may be filtered. For example, an image frame with a high quality score may be selected as a target face image for subsequent face recognition, reducing a number of recognition operations during face recognition, reducing processing resource waste caused by poor face image quality or nonexistence of any face image, improving face recognition efficiency, improving face recognition accuracy.

Face recognition performed on an image frame in an image frame sequence may be a consuming processing process, not every image frame collected by an image collecting device will be processed. Instead, image frames for face recognition may be acquired according to a processing period. This will lead to serious frame loss. A discarded image frame may be of high quality and suitable for face recognition, while an image frame acquired for face recognition may be of low quality. Alternatively, acquired image frames may include no face image, not only wasting lots of valid image frames, but also leading to low face recognition efficiency.

With a solution for processing an image herein, before face recognition, image frames in an image frame sequence are filtered, acquiring an image frame including a high quality face image for face recognition, thereby reducing valid image frame waste, speeding up face recognition, improving face recognition accuracy, reducing processing resource waste.

A solution for processing an image herein is described below through embodiments.

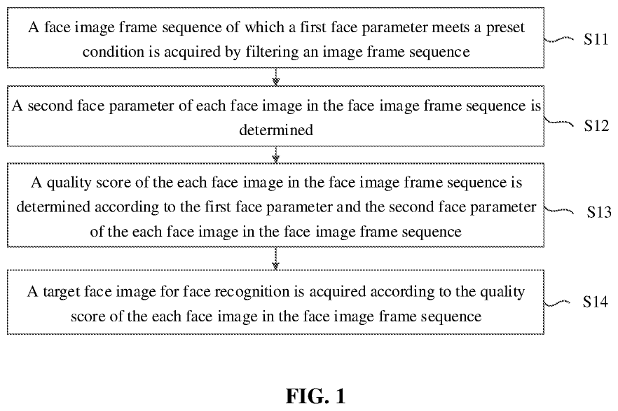

FIG. 1 is a flowchart of a method for processing an image according to an embodiment herein. The method for processing an image may be executed by terminal equipment, a server, or other information processing equipment. Terminal equipment may be access control equipment, face recognition equipment, User Equipment (UE), mobile equipment, a user terminal, a terminal, a cell phone, a cordless phone, a Personal Digital Assistant (PDA), handheld equipment, computing equipment, on-board equipment, wearable equipment, etc. In some possible implementations, the method for processing an image may be implemented by a processor by calling computer-readable instructions stored in memory. A solution for processing an image herein is described below, which is implemented by an image processing terminal, for example.

As shown in FIG. 1, the method for processing an image includes a step as follows.

In operation S11, a face image frame sequence of which a first face parameter meets a preset condition is acquired by filtering an image frame sequence.

Herein, an image processing terminal may continuously collect image frames. The continuously collected image frames may form an image frame sequence. Alternatively, an image processing terminal may be provided with an image collecting device. The image processing terminal may acquire an image frame sequence collected by the image collecting device. For example, every time the image collecting device collects an image frame, the image processing terminal may acquire the image frame collected by the image collecting device. After the image processing terminal has acquired the image frame sequence, a first face parameter of any image frame of the image frame sequence may be acquired. The image frame sequence may be filtered using the first face parameters of the image frames. The image frame sequence may be filtered by determining whether the first face parameter of each image frame meets the preset condition. If the first face parameter of the each image frame meets the preset condition, the each image frame may be determined as an image face in the face image frame sequence. If the first face parameter of the each image frame does not meet the preset condition, the each image frame may be discarded. The next image frame may continue to be filtered.

Here, a first face parameter may be a parameter related to a face image recognition rate. For example, the first face parameter may be a parameter representing the completeness of the face image in an image frame. Exemplarily, the greater a first face parameter is, the more complete the face image, namely, the greater the face image recognition rate. The preset condition may be a basic condition to be met by the face image in the image frame. For example, the preset condition may be that there is a face image in the image frame. As another example, the preset condition may be that there is a target key point, such as an eye key point, a mouth key point, etc., in the face image in the image frame. As another example, the preset condition may be that a contour of the face image in the image frame is continuous. By acquiring a face image frame sequence of which a first face parameter meets a preset condition in an image frame sequence, image frames in the image frame sequence may be filtered preliminarily, removing any image frame with no face image or with an incomplete face image in the image frame sequence.

In a possible implementation, the first face parameter may include at least one of a face image width, a face image height, a face image coordinate, a face image alignment, a face image posture angle, etc.

Here, a face image width may represent a maximum image width corresponding to a face image in an image frame. A face image height may represent a maximum pixel width corresponding to a face image in an image frame. A face image coordinate may represent an image coordinate of a pixel of a face image in an image frame. For example, an image coordinate system at a center point of the image frame may be established. The image coordinate may be a coordinate of the pixel in the image coordinate system. A face image alignment may represent a matching degree between a key point of a face image and a key point of a preset face template. For example, an image coordinate of a mouth key point of a face image in an image frame may be A. An image coordinate of a mouth key point in the preset face template may be B. The face image alignment may include a distance between the image coordinate A and the image coordinate B. The less the distance between the image coordinate A and the image coordinate B is, the greater the matching degree between the mouth key point of the face image and the mouth key point of the preset face template, namely, the greater the face image alignment. The greater the distance between the image coordinate A and the image coordinate B, the less a matching degree between the mouth key point of the face image and the mouth key point of the preset face template, namely, the less the face image alignment. A face image posture angle may represent a posture of a face image. Exemplarily, the face image posture angle may include at least one of a yaw angle, a roll angle, and a pitch angle. For example, a face image of an image frame may be compared to the preset face template, determining a yaw angle, a roll angle, and a pitch angle of the image face of the image frame with respect to a standard axis of the preset face template.

In operation S12, a second face parameter of each face image in the face image frame sequence is determined.

Herein, a second face parameter may be a parameter related to the face image recognition rate. There may be one or more second face parameters. When there are multiple second face parameters, individual second face parameters may be independent of each other. In addition, each second face parameter may also be independent of each first face parameter. Accordingly, recognizability of the face image may be evaluated using both the first face parameter and the second face parameter.

In a possible implementation, the second face parameter may include at least one of a face image sharpness, a face image brightness, a face image pixel number, etc. A face image sharpness may represent a contrast between a contour of a face region of a face image and a pixel near the contour. The greater a face image sharpness is, the clearer a face image of an image frame. The less a face image sharpness is, the more blurred a face image in an image frame. Exemplarily, a face image sharpness here may be an average image sharpness of a face image. A face image brightness may represent an image brightness corresponding to a face region of a face image. Exemplarily, a face image brightness here may be an average image brightness of a face region. A face image pixel number may represent a number of pixels in a face region in a face image. The face image sharpness, the face image brightness, and the face image pixel number may be important parameters influencing the face image recognition rate. Accordingly, before face recognition is performed on an image frame, one or more second face parameters of the face image sharpness, the face image brightness, and the face image pixel number of each face image in a face image frame sequence may be determined.

In operation S13, a quality score of the each face image in the face image frame sequence is determined according to the first face parameter and the second face parameter of the each face image in the face image frame sequence.

Herein, both a first face parameter and a second face parameter may be used to evaluate face quality of a face image. An image processing terminal may give a score to face quality of each face image combining both the first face parameter and the second face parameter of the each face image, acquiring a quality score of each face image in a face image frame sequence. A quality score may be used to represent face quality of a face image. For example, the higher a quality score is, the higher the face quality of a face image. The lower a quality score is, the lower the face quality of a face image.

In a possible implementation, S13 may include an option as follows. Weighting processing may be performed on the first face parameter and the second face parameter of the each face image. The quality score of the each face image may be acquired based on a weighting processing result.

In the implementation, an image processing terminal may acquire a quality score of each face image in a face image frame sequence by weighting a first face parameter and a second face parameter. Weights corresponding respectively to the first face parameter and the second face parameter may be set. Different face parameters may correspond to different weights. A weight corresponding to a face parameter may be set according to a correlation between the face parameter and a face image recognition rate. For example, if a face parameter has more influence on the face image recognition rate, a large weight may be set for the face parameter. If a face parameter has less influence on the face image recognition rate, a small weight may be set for the face parameter. By performing weighting processing on face parameters using weights corresponding to the first face parameter and the second face parameter, influence of multiple face parameters on the face image recognition rate may be considered comprehensively, and quality of each face image in a face image frame sequence may be evaluated using a quality score.

In another possible implementation, S13 may further include an option as follows. A parameter score corresponding to each of the first face parameter and the second face parameter may be determined respectively according to a correlation between the each of the first face parameter and the second face parameter and a face image recognition rate. The quality score of the each face image may be determined according to the parameter score corresponding to the each of the first face parameter and the second face parameter.

In the implementation, for each face image in a face image frame sequence, an image processing terminal may acquire a parameter score corresponding to each of the first face parameter and the second face parameter according to a correlation between each of the first face parameter and the second face parameter of the each face image and a face image recognition rate. Then, the image processing terminal may acquire a sum or a product of the acquired parameter score of each face parameter as the quality score of the each face image. The parameter score of each face parameter may be computed according to the correlation between the each face parameter and the face image recognition rate. For example, a face parameter may be positively correlated with the face image recognition rate. Accordingly, a mode of computation positively correlated with the recognition rate may be set with the face parameter, determining the parameter score of the face parameter. When the quality score of each face parameter in the face image frame sequence is determined in this way, a distinct mode of computing a parameter score may be set for a distinct face parameter according to the correlation between the distinct face parameter and the face image recognition rate, rendering the acquired quality score of a face image more accurate.

In operation S14, a target face image for face recognition is acquired according to the quality score of the each face image in the face image frame sequence.

Herein, a quality score may represent recognizability of a face image. Understandably, the higher the quality score is, the more recognizable the face image. The lower the quality score is, the less recognizable the face image. Therefore, a target face image for subsequent face recognition may be acquired by filtering the face image frame sequence according to the determined quality score of the each face image in the face image frame sequence. For example, a face image with a quality score greater than a preset score threshold may be selected as a target face image for face recognition. Alternatively, a face image with a highest quality score may be selected as the target face image for face recognition, improving face recognition efficiency and accuracy.

In a possible implementation, in S14, the target face image for face recognition may be acquired according to the quality score of the each face image in the face image frame sequence as follows. A face image to be stored in a cache queue may be determined according to the quality score. A sorting result may be acquired by sorting multiple face images in the cache queue. The target face image for face recognition may be acquired according to the sorting result.

In the implementation, the face image frame sequence may be filtered according to the quality score of the each face image in the face image frame sequence, determining a face image in the face image frame sequence to be stored in a cache queue. Furthermore, face images stored in the cache queue may be sorted according to quality scores of the face images in the cache queue. For example, the face images in the cache queue may be sorted in an order of descending quality scores of face images, acquiring a sorting result. Then, a target face image for face recognition in the cache queue may be determined according to the sorting result. In this way, the face images in the face image frame sequence may be filtered for a number of times, determining the target face image ultimately used for face recognition, improving subsequent face recognition efficiency and accuracy.

In an example, the face image to be stored in the cache queue may be determined according to the quality score as follows. The quality score of the each face image may be compared to a preset score threshold. If the quality score of the face image is greater than the preset score threshold, it may be determined to store the face image in the cache queue.

In the example, for each image frame in the face image frame sequence, the quality score of the face image may be compared to the preset score threshold, determining whether the quality score of the face image is greater than the score threshold. If the quality score of the face image is greater than the preset score threshold, it may be deemed that the face of the face image is high quality, and the face image may be stored in the cache queue. When the quality score of the face image is less than or equal to the preset score threshold, it may be deemed that the face of the face image is of poor quality, and the face image may be discarded. Herein, it may be determined, cyclically using a separate thread, whether to store a face image in the cache queue. That is, an image processing terminal may determine whether to store a face images in the cache queue, and sort the multiple face images in the cache queue, simultaneously, thereby improving image frame processing efficiency.

In an example, the target face image for face recognition may be acquired according to the sorting result as follows. A face image with a highest quality score in the cache queue may be determined according to the sorting result. The face image with the highest quality score in the cache queue may be determined as the target face image for face recognition.

In the example, the image processing terminal may select the face image with the highest quality score in the cache queue according to the sorting result, and determine the face image with the highest quality score as the target face image for face recognition. In this way, each target face image for face recognition is the face image with the highest quality score in the cache queue. The higher the quality score is, the more recognizable the face image. Accordingly, face quality of the target face image for face recognition may be ensured through the quality score, improving face recognition efficiency and accuracy.

Herein, after the target face image for face recognition in the face image frame sequence has been determined, face recognition may be performed on the determined target face image. Since the target face image is of high face quality, the number of comparisons during face recognition may be reduced, saving a processing resource and equipment power. After the target face image has been determined, a face image in the cache queue matching the face in the target face image may be deleted. That is, face images with the same face may be deleted. In this way, face images cached in the cache queue may be reduced, saving a storage space.

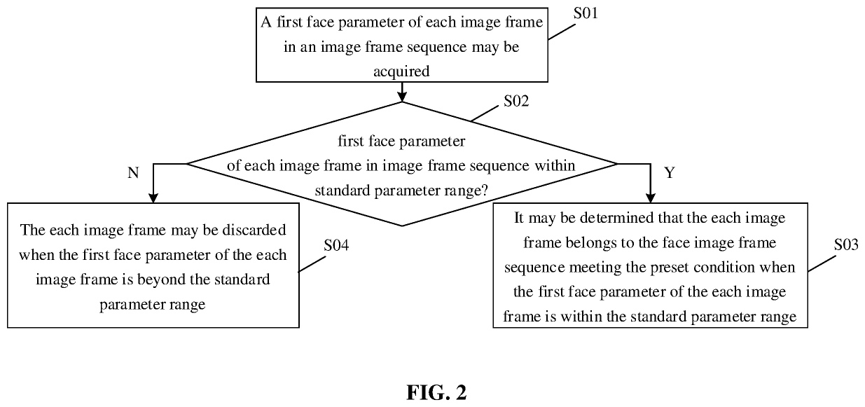

FIG. 2 is a flowchart of determining a face image frame sequence according to an exemplary embodiment herein.

In a possible implementation, the preset condition may include that the first face parameter is within a standard parameter range as preset. Before the face image frame sequence of which the first face parameter meets the preset condition is acquired by filtering the image frame sequence in S11, the method may include a step as follows.

In operation S01, the first face parameter of each image frame in the image frame sequence may be acquired.

In the implementation, first, the image processing terminal may detect a face region in each image frame, to locate the face region in each image frame, and then determine the first face parameter of each image frame in the image frame sequence according to the located face region. For example, the first face parameter such as the face image coordinate and the face image height of the face region may be determined.

In an example, the first face parameter of the each image frame in the image frame sequence may be acquired as follows. Orientation information and location information of an image collecting device configured for collecting the image frame sequence may be acquired. Face orientation information of the each image frame in the image frame sequence may be determined according to the orientation information and the location information of the image collecting device. The first face parameter of the each image frame may be acquired based on the face orientation information.

In the example, an image collecting device may be a device configured for collecting the image frame sequence. An image processing terminal may include the image collecting device. An approximate orientation and an approximate angle of the face in an image frame collected by the image collecting device may be determined according to the orientation and the location of the image collecting device during photography. Therefore, before the first face parameter of each image frame in the image frame sequence is acquired, information on the orientation and the location of the image collecting device may be acquired. Face orientation information of an image frame may be determined according to the orientation information and the location information of the image collecting device. The orientation of the face in the image frame may be estimated roughly according to the face orientation information. For example, the face in the image frame may be to the left or to the right. The face region in each image frame may be located rapidly according to the face orientation information, determining an image location of the face region, thereby acquiring the first face parameter of each image frame.

In operation S02, it may be determined whether a first face parameter of each image frame in an image frame sequence is within a standard parameter range.

Here, for each image frame in the image frame sequence, the image processing terminal may compare one or more first face parameters of the image frame to a corresponding standard parameter range, determining whether the one or more first face parameters of the image frame are in the corresponding standard parameter range. If a first face parameter of the image frame is within the standard parameter range, S03 may be implemented. Otherwise, S04 may be implemented. In this way, image frames in the image frame sequence may be filtered preliminarily by determining whether a first face parameter is within a standard parameter range.

In operation S03, it may be determined that the each image frame belongs to the face image frame sequence meeting the preset condition when the first face parameter of the each image frame is within the standard parameter range.

Herein, if the first parameter is in the standard parameter range as preset, it may be determined that there is a face in the image frame. Alternatively, it may be determined that the face region in the image frame is relatively complete, and the image frame is a face image in the face image frame sequence and is kept.

In an example, the first face parameter may include a face image coordinate. It may be determined that the each image frame belongs to the face image frame sequence meeting the preset condition if the first face parameter of the each image frame is within the standard parameter range, as follows. It may be determined t that the each image frame belongs to the face image frame sequence meeting the preset condition if the face image coordinate is within a standard coordinate range.

In the example, a first face parameter may be a face image coordinate. Then, a face image coordinate of a current image frame in the image frame sequence may be compared to a preset standard image coordinate range. Assuming that face image coordinates of the current image frame are (x1, y1), it may be determined whether the x1 is in a range [left, right] corresponding to an abscissa in the standard image coordinate range and whether the y1 is in a range [bottom, top] corresponding to an ordinate in the standard image coordinate range. If the x1 is in the range [left, right] and the y1 is in the range [bottom, top], it may be determined that the current image frame belongs to the face image frame sequence meeting the preset condition.

In operation S04, if the first face parameter is beyond the standard parameter range, the each image frame may be discarded.

In the implementation, if the first parameter of the each image frame is not in the standard parameter range as preset, it may be deemed that there is no face in the image frame or the face region in the image frame is incomplete, the image frame may be discarded, and a next image frame may continue to be detected. The first face parameter of an image frame including no face image may be 0. Accordingly, the image frame sequence may be filtered preliminarily through first face parameters, screening out any image frame in the image frame sequence that includes no face image or has an unqualified first face parameter.

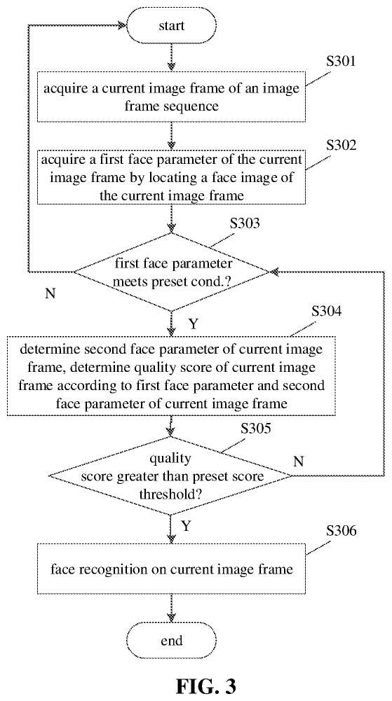

FIG. 3 is s a flowchart of processing an image according to an exemplary embodiment herein. In the example, an image processing process may include a step as follows.

In operation S301, a current image frame of an image frame sequence may be acquired.

In operation S302, a first face parameter of the current image frame may be acquired by locating a face region of the current image frame.

Herein, the first face parameter may include at least one of a face image width, a face image height, a face image coordinate, a face image alignment, or a face image posture angle.

In operation S303, it may be determined whether the first face parameter of the current image frame meets a preset condition.

Herein, the preset condition may include that the first face parameter is within a standard parameter range as preset. Therefore, it may be determined whether a first face parameter is in the standard parameter range of the first face parameter. If each first face parameter is within the standard parameter range of the each first face parameter, it may be determined that the current image frame has a complete face image, and S304 may be implemented. Otherwise, it may be determined that the current image frame includes no face or includes an incomplete face, and a new image frame may be acquired. That is, S301 may be implemented again.

In operation S304, when the first face parameter meets the preset condition, a second face parameter of the current image frame may be determined. A quality score of the current image frame may be determined according to the first face parameter and the second face parameter of the current image frame.

Herein, the second face parameter may include at least one of a face image sharpness, a face image brightness, or a face image pixel number In operation S305, it may be determined whether the quality score of the current image frame is greater than a preset score threshold.

Herein, if the quality score of the current image frame is greater than the preset score threshold, it may be deemed that the face in the current image frame is of high quality, and S306 may be implemented. If the quality score is less than or equal to the preset score threshold, it may be deemed that the face in the current image frame is of poor quality, and S303 may be implemented again.

In operation S306, face recognition may be performed on the current image frame.

With a solution for processing an image herein, before face recognition, image frames in an image frame sequence are filtered, acquiring an image frame including a high quality face image for face recognition, thereby reducing valid image frame waste, speeding up face recognition, improving face recognition accuracy, reducing processing resource waste.

Understandably, embodiments of a method herein may be combined with each other to form a combined embodiment as long as the combination does not go against a principle or a logic, which is not elaborated herein due to a space limitation.

In addition, embodiments herein further provide a device for processing an image, electronic equipment, a computer-readable storage medium, and a program, all of which may be adapted to implementing any method for processing an image provided herein. Refer to disclosure for a method herein for a technical solution thereof and description therefor, which is not elaborated.

A person having ordinary skill in the art may understand that in a method herein, the order in which the steps are put is not necessarily a strict order in which the steps are implemented, and does not form any limitation to the implementation. A specific order in which the steps are implemented should be determined based on a function and a possible intrinsic logic thereof.

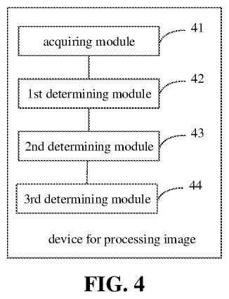

FIG. 4 is a block diagram of a device for processing an image according to an embodiment herein. As shown in FIG. 4, the device for processing an image includes an acquiring module, a first determining module, a second determining module, and a third determining module.

The acquiring module 41 is configured for acquiring, by filtering an image frame sequence, a face image frame sequence of which a first face parameter meets a preset condition.

The first determining module 42 is configured for determining a second face parameter of each face image in the face image frame sequence.

The second determining module 43 is configured for determining a quality score of the each face image in the face image frame sequence according to the first face parameter and the second face parameter of the each face image in the face image frame sequence.

The third determining module 44 is configured for acquiring a target face image for face recognition according to the quality score of the each face image in the face image frame sequence.

In a possible implementation, the preset condition may include that the first face parameter is within a standard parameter range as preset. The device may further include a judging module.

The judging module may be configured for: before acquiring, by the acquiring module 41 by filtering the image frame sequence, the face image frame sequence of which the first face parameter meets the preset condition, acquiring the first face parameter of each image frame in the image frame sequence; and determining that the each image frame belongs to the face image frame sequence meeting the preset condition in response to the first face parameter of the each image frame being within the standard parameter range.

In a possible implementation, the judging module may be configured for: acquiring orientation information and location information of an image collecting device configured for collecting the image frame sequence; determining face orientation information of the each image frame in the image frame sequence according to the orientation information and the location information of the image collecting device; and acquiring the first face parameter of the each image frame based on the face orientation information.

In a possible implementation, the first face parameter may include a face image coordinate.

The judging module may be configured for determining that the each image frame belongs to the face image frame sequence meeting the preset condition in response to the face image coordinate being within a standard coordinate range.

In a possible implementation, the first face parameter may include at least one of a face image width, a face image height, a face image coordinate, a face image alignment, or a face image posture angle.

In a possible implementation, the second determining module 43 may be configured for performing weighting processing on the first face parameter and the second face parameter of the each face image, and acquiring the quality score of the each face image based on a weighting processing result.

In a possible implementation, the second determining module 43 may be configured for: determining a parameter score corresponding to each of the first face parameter and the second face parameter respectively according to a correlation between the each of the first face parameter and the second face parameter and a face image recognition rate; and determining the quality score of the each face image according to the parameter score corresponding to the each of the first face parameter and the second face parameter.

In a possible implementation, the third determining module 44 may be configured for: determining a face image to be stored in a cache queue according to the quality score; acquiring a sorting result by sorting multiple face images in the cache queue; and acquiring the target face image for face recognition according to the sorting result.

In a possible implementation, the third determining module 44 may be configured for: comparing the quality score of the each face image to a preset score threshold; and in response to the quality score of the face image being greater than the preset score threshold, determining to store the face image in the cache queue.

In a possible implementation, the third determining module 44 may be configured for: determining a face image with a highest quality score in the cache queue according to the sorting result; and determining the face image with the highest quality score in the cache queue as the target face image for face recognition.

In a possible implementation, the second face parameter may include at least one of a face image sharpness, a face image brightness, or a face image pixel number.

In some embodiments, a function or a module of a device herein may be used for implementing a method herein. Refer to description of a method herein for specific implementation of a device herein, which is not repeated here for brevity.

Embodiments herein further propose a computer-readable storage medium, having stored thereon computer program instructions which, when executed by a processor, implement a method herein. The computer-readable storage medium may be a nonvolatile computer-readable storage medium.

Embodiments herein further propose electronic equipment, which includes a processor and memory configured for storing instructions executable by the processor. The processor is configured for implementing a method herein.

Exemplarily, electronic equipment may be provided as a terminal, a server, or equipment in another form.

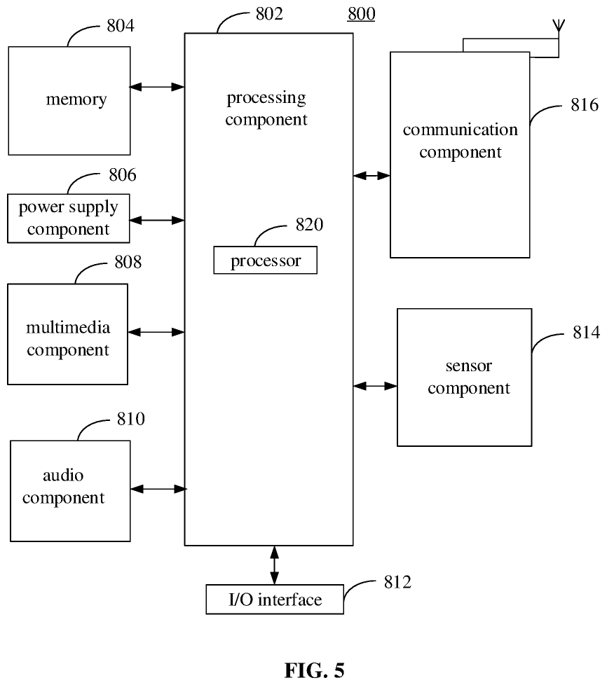

FIG. 5 is a block diagram of electronic equipment according to an exemplary embodiment. For example, the electronic equipment may be a terminal such as a mobile phone, a computer, a digital broadcasting terminal, a message transceiver, a game console, tablet equipment, medical equipment, fitness equipment, a Personal Digital Assistant (PDA), etc.

Referring to FIG. 5, the electronic equipment 800 may include one or more of a processing component 802, memory 804, a power supply component 806, a multimedia component 808, an audio component 810, an Input/Output (I/O) interface 812, a sensor component 814, a communication component 816, etc.

The processing component 802 may generally control an overall operation of the electronic equipment 800, such as operations associated with display, a telephone call, data communication, a camera operation, a recording operation, etc. The processing component 802 may include one or more processors 820 to execute instructions, so as to complete all or some steps of the method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 may be adapted to storing various types of data to support the operation at the equipment 800. Examples of such data may include instructions of any application or method adapted to operating on the electronic equipment 800, contact data, phone book data, messages, pictures, videos, etc. The memory 804 may be realized by any type of transitory or non-transitory storage equipment or combination thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, a magnetic disk, or a compact disk.

The power supply component 806 may supply electric power to various components of the electronic equipment 800. The power supply component 806 may include a power management system, one or more power sources, and other components related to generating, managing and distributing electricity for the electronic equipment 800.

The multimedia component 808 may include a filter providing an output interface between the electronic equipment 800 and a user. The filter may include a Liquid Crystal Display (LCD), a Touch Panel (TP), etc. If the filter includes a TP, the filter may be realized as a touch filter to receive an input signal from a user. The TP may include one or more touch sensors for sensing touch, slide and gestures on the TP. The touch sensors not only may sense the boundary of a touch or slide move, but also detect the duration and pressure related to the touch or slide move. The multimedia component 808 may include a front camera and/or a rear camera. When the electronic equipment 800 is in an operation mode such as a photographing mode or a video mode, the front camera and/or the rear camera may receive external multimedia data. Each of the front camera or the rear camera may be a fixed optical lens system or may have a focal length and be capable of optical zooming.

The audio component 810 may be adapted to outputting and/or inputting an audio signal. For example, the audio component 810 may include a microphone (MIC). When the electronic equipment 800 is in an operation mode such as a call mode, a recording mode, and a voice recognition mode, the MIC may be adapted to receiving an external audio signal. The received audio signal may be further stored in the memory 804 or may be sent via the communication component 816. The audio component 810 may further include a loudspeaker adapted to outputting the audio signal.

The I/O interface 812 may provide an interface between the processing component 802 and a peripheral interface module. Such a peripheral interface module may be a keypad, a click wheel, a button, and/or the like. Such a button may include but is not limited to: a homepage button, a volume button, a start button, and a lock button.

The sensor component 814 may include one or more sensors for assessing various states of the electronic equipment 800. For example, the sensor component 814 may detect an on/off state of the electronic equipment 800 and relative location of components such as the display and the keypad of the electronic equipment 800. The sensor component 814 may further detect a change in the location of the electronic equipment 800 or of a component of the deice 800, whether there is contact between the electronic equipment 800 and a user, the orientation or acceleration/deceleration of the electronic equipment 800, a change in the temperature of the electronic equipment 800. The sensor component 814 may include a proximity sensor adapted to detecting existence of a nearby object without physical contact. The sensor component 814 may further include an optical sensor such as a Complementary Metal-Oxide-Semiconductor (CMOS) or a Charge-Coupled-Device (CCD) image sensor used in an imaging application. The sensor component 814 may further include an acceleration sensor, a gyroscope sensor, a magnetic sensor, a pressure sensor, or a temperature sensor.

The communication component 816 may be adapted to facilitating wired or wireless communication between the electronic equipment 800 and other equipment. The electronic equipment 800 may access a wireless network based on a communication standard such as Wi-Fi, 2G, 3G . . . , or combination thereof. The communication component 816 may broadcast related information or receive a broadcast signal from an external broadcast management system via a broadcast channel. The communication component 816 may further include a Near Field Communication (NFC) module for short-range communication. For example, the NFC module may be based on technology such as Radio Frequency Identification (RFID), Infrared Data Association (IrDA), Ultra-Wideband (UWB) technology, Bluetooth (BT), etc.

The electronic equipment 800 may be realized by one or more electronic components such as an Application Specific Integrated Circuit (ASIC), a Digital Signal Processor (DSP), a Digital Signal Processing Device (DSPD), a Programmable Logic Device (PLD), a Field-Programmable Gate Array (FPGA), a controller, a microcontroller, a microprocessor, etc., to implement the method.

In an exemplary embodiment, a non-transitory computer-readable storage medium including, such as memory 804 including computer program instructions, may be provided. The computer program instructions may be executed by the processor 820 of the electronic equipment 800 to implement the method.

Embodiments herein may be a system, a method, and/or a computer program product. The computer program product may include a computer-readable storage medium, having borne thereon computer-readable program instructions allowing a processor to implement various aspects herein.

A computer-readable storage medium may be tangible equipment capable of keeping and storing an instruction used by instruction executing equipment. For example, a computer-readable storage medium may be, but is not limited to, electric storage equipment, magnetic storage equipment, optical storage equipment, electromagnetic storage equipment, semiconductor storage equipment, or any appropriate combination thereof. A non-exhaustive list of more specific examples of a computer-readable storage medium may include a portable computer disk, a hard disk, Random Access Memory (RAM), Read-Only Memory (ROM), Erasable Programmable Read-Only Memory (EPROM, or flash memory), Static Random Access Memory (SRAM), Compact Disc Read-Only Memory (CD-ROM), a Digital Versatile Disk (DVD), memory stick, a floppy disk, mechanical coding equipment such as a protruding structure in a groove or a punch card having stored thereon an instruction, as well as any appropriate combination thereof. A computer-readable storage medium used here may not be construed as a transient signal per se, such as a radio wave, another freely propagated electromagnetic wave, an electromagnetic wave propagated through a wave guide or another transmission medium (such as an optical pulse propagated through an optical fiber cable), or an electric signal transmitted through a wire.

A computer-readable program instruction described here may be downloaded from a computer-readable storage medium to respective computing/processing equipment, or to an external computer or external storage equipment through a network such as the Internet, a Local Area Network (LAN), a Wide Area Network (WAN), and/or a wireless network. A network may include a copper transmission cable, optical fiber transmission, wireless transmission, a router, a firewall, a switch, a gateway computer, and/or an edge server. A network adapter card or a network interface in respective computing/processing equipment may receive the computer-readable program instruction from the network, and forward the computer-readable program instruction to computer-readable storage media in respective computing/processing equipment.

Computer program instructions for implementing an operation herein may be an assembly instruction, an Instruction Set Architecture (ISA) instruction, a machine instruction, a machine related instruction, a microcode, a firmware instruction, state setting data, or a source code or object code written in any combination of one or more programming languages. A programming language may include an object-oriented programming language such as Smalltalk, C++, etc., as well as a conventional procedural programming language such as C or a similar programming language. Computer-readable program instructions may be executed on a computer of a user entirely or in part, as a separate software package, partly on the computer of the user and partly on a remote computer, or entirely on a remote computer/server. When a remote computer is involved, the remote computer may be connected to the computer of a user through any type of network including an LAN or a WAN. Alternatively, the remote computer may be connected to an external computer (such as connected through the Internet using an Internet service provider). In some embodiments, an electronic circuit such as a programmable logic circuit, a Field-Programmable Gate Array (FPGA), or a Programmable Logic Array (PLA) may be customized using state information of a computer-readable program instruction. The electronic circuit may execute the computer-readable program instruction, thereby implementing an aspect herein.

Aspects herein have been described with reference to flowcharts and/or block diagrams of the method, device (system), and computer program product herein. It is be understood that each block in the flowcharts and/or the block diagrams and a combination of respective blocks in the flowcharts and/or the block diagrams may be implemented by computer-readable program instructions.

These computer-readable program instructions may be provided to a general-purpose computer, a dedicated computer, or a processor of another programmable data processing device, thereby producing a machine to allow the instruction to produce, when executed through a computer or the processor of another programmable data processing device, a device implementing a function/move specified in one or more blocks in the flowcharts and/or the block diagrams. The computer-readable program instructions may also be stored in a computer-readable storage medium. The instructions allow a computer, a programmable data processing device and/or other equipment to work in a specific mode. Accordingly, the computer-readable medium including the instructions includes a manufactured article including instructions for implementing each aspect of a function/move specified in one or more blocks in the flowcharts and/or the block diagrams.

Computer-readable program instructions may also be loaded to a computer, another programmable data processing device, or other equipment, such that a series of operations are executed in the computer, the other programmable data processing device, or the other equipment to produce a computer implemented process, thereby allowing the instructions executed on the computer, the other programmable data processing device, or the other equipment to implement a function/move specified in one or more blocks in the flowcharts and/or the block diagrams.

The flowcharts and block diagrams in the drawings show possible implementation of architectures, functions, and operations of the system, method, and computer program product according to multiple embodiments herein. In this regard, each block in the flowcharts or the block diagrams may represent part of a module, a program segment, or an instruction. The part of the module, the program segment, or the instruction includes one or more executable instructions for implementing a specified logical function. In some alternative implementations, functions noted in the blocks may also occur in an order different from that noted in the drawings. For example, two consecutive blocks may actually be implemented basically in parallel. They sometimes may also be implemented in a reverse order, depending on the functions involved. Also note that each block in the block diagrams and/or the flowcharts, as well as a combination of the blocks in the block diagrams and/or the flowcharts, may be implemented by a hardware-based application-specific system for implementing a specified function or move, or by a combination of an application-specific hardware and a computer instruction.

Description of embodiments herein is exemplary, not exhaustive, and not limited to the embodiments disclosed herein. Various modification and variations can be made without departing from the principle of embodiments herein. The modification and variations will be apparent to a person having ordinary skill in the art. Choice of a term used herein is intended to best explain the principle and/or application of the embodiments, or improvement to technology in the market, or allow a person having ordinary skill in the art to understand the embodiments disclosed herein.

With embodiments herein, a face image frame sequence of which a first face parameter meets a preset condition is acquired by filtering an image frame sequence. A second face parameter of each face image in the face image frame sequence is determined. A quality score of the each face image in the face image frame sequence is determined according to the first face parameter and the second face parameter of the each face image in the face image frame sequence. A target face image for face recognition is acquired according to the quality score of the each face image in the face image frame sequence. In this way, before face recognition, first, a face image frame sequence is acquired by filtering an image frame sequence according to a first face parameter. Then, the image frame sequence is filtered again according to a quality score of a face image in the face image frame sequence, acquiring a target face image of high face quality for subsequent face recognition, thereby reducing processing resource waste during face recognition, improving face recognition efficiency.

What is claimed is:

1. A method for processing an image, comprising:
acquiring, by filtering an image frame sequence, a face image frame sequence of which a first face parameter meets a preset condition;
determining a second face parameter of each face image in the face image frame sequence;
determining a quality score of the each face image in the face image frame sequence according to the first face parameter and the second face parameter of the each face image in the face image frame sequence; and
acquiring a target face image for face recognition according to the quality score of the each face image in the face image frame sequence.

2. The method of claim 1, wherein the preset condition comprises that the first face parameter is within a standard parameter range as preset, wherein the method further comprises: before acquiring, by filtering the image frame sequence, the face image frame sequence of which the first face parameter meets the preset condition,
acquiring the first face parameter of each image frame in the image frame sequence; and
determining that the each image frame belongs to the face image frame sequence meeting the preset condition in response to the first face parameter of the each image frame being within the standard parameter range.

3. The method of claim 2, wherein acquiring the first face parameter of the each image frame in the image frame sequence comprises:
acquiring orientation information and location information of an image collecting device configured for collecting the image frame sequence;
determining face orientation information of the each image frame in the image frame sequence according to the orientation information and the location information of the image collecting device; and
acquiring the first face parameter of the each image frame based on the face orientation information.

4. The method of claim 2, wherein the first face parameter comprises a face image coordinate, wherein determining that the each image frame belongs to the face image frame sequence meeting the preset condition in response to the first face parameter of the each image frame being within the standard parameter range comprises:
determining that the each image frame belongs to the face image frame sequence meeting the preset condition in response to the face image coordinate being within a standard coordinate range.

5. The method of claim 1, wherein the first face parameter comprises at least one of a face image width, a face image height, a face image coordinate, a face image alignment, or a face image posture angle.

6. The method of claim 1, wherein determining the quality score of the each face image in the face image frame sequence according to the first face parameter and the second face parameter of the each face image in the face image frame sequence comprises:
performing weighting processing on the first face parameter and the second face parameter of the each face image, and acquiring the quality score of the each face image based on a weighting processing result.

7. The method of claim 1, wherein determining the quality score of the each face image in the face image frame sequence according to the first face parameter and the second face parameter of the each face image in the face image frame sequence comprises:
determining a parameter score corresponding to each of the first face parameter and the second face parameter respectively according to a correlation between the each of the first face parameter and the second face parameter and a face image recognition rate; and
determining the quality score of the each face image according to the parameter score corresponding to the each of the first face parameter and the second face parameter.

8. The method of claim 1, wherein acquiring the target face image for face recognition according to the quality score of the each face image in the face image frame sequence comprises:
determining a face image to be stored in a cache queue according to the quality score;
acquiring a sorting result by sorting multiple face images in the cache queue; and
acquiring the target face image for face recognition according to the sorting result.

9. The method of claim 8, wherein determining the face image to be stored in the cache queue according to the quality score comprises:
comparing the quality score of the each face image to a preset score threshold; and
in response to the quality score of the face image being greater than the preset score threshold, determining to store the face image in the cache queue.

10. The method of claim 8, wherein acquiring the target face image for face recognition according to the sorting result comprises:
determining a face image with a highest quality score in the cache queue according to the sorting result; and
determining the face image with the highest quality score in the cache queue as the target face image for face recognition.

11. The method of claim 1, wherein the second face parameter comprises at least one of a face image sharpness, a face image brightness, or a face image pixel number.

12. Electronic equipment, comprising a processor and memory,
wherein the memory is configured for storing instructions executable by the processor.
wherein the processor is configured, by calling the instructions stored in the memory, to implement:
acquiring, by filtering an image frame sequence, a face image frame sequence of which a first face parameter meets a preset condition;
determining a second face parameter of each face image in the face image frame sequence;
determining a quality score of the each face image in the face image frame sequence according to the first face parameter and the second face parameter of the each face image in the face image frame sequence; and
acquiring a target face image for face recognition according to the quality score of the each face image in the face image frame sequence.

13. The electronic equipment of claim 12, wherein the preset condition comprises that the first face parameter is within a standard parameter range as preset, wherein the processor is further configured for: before acquiring, by filtering the image frame sequence, the face image frame sequence of which the first face parameter meets the preset condition,
acquiring the first face parameter of each image frame in the image frame sequence; and
determining that the each image frame belongs to the face image frame sequence meeting the preset condition in response to the first face parameter of the each image frame being within the standard parameter range.

14. The electronic equipment of claim 13, wherein the processor is configured for acquiring the first face parameter of the each image frame in the image frame sequence by:
acquiring orientation information and location information of an image collecting device configured for collecting the image frame sequence;
determining face orientation information of the each image frame in the image frame sequence according to the orientation information and the location information of the image collecting device; and
acquiring the first face parameter of the each image frame based on the face orientation information.

15. The electronic equipment of claim 12, wherein the first face parameter comprises at least one of a face image width, a face image height, a face image coordinate, a face image alignment, or a face image posture angle.

16. The electronic equipment of claim 12, wherein the processor is configured for determining the quality score of the each face image in the face image frame sequence according to the first face parameter and the second face parameter of the each face image in the face image frame sequence by:
performing weighting processing on the first face parameter and the second face parameter of the each face image, and acquiring the quality score of the each face image based on a weighting processing result.

17. The electronic equipment of claim 12, wherein the processor is configured for determining the quality score of the each face image in the face image frame sequence according to the first face parameter and the second face parameter of the each face image in the face image frame sequence by:
determining a parameter score corresponding to each of the first face parameter and the second face parameter respectively according to a correlation between the each of the first face parameter and the second face parameter and a face image recognition rate; and
determining the quality score of the each face image according to the parameter score corresponding to the each of the first face parameter and the second face parameter.

18. The electronic equipment of claim 12 electronic equipment of claim 12, wherein the processor is configured for acquiring the target face image for face recognition according to the quality score of the each face image in the face image frame sequence by:
determining a face image to be stored in a cache queue according to the quality score;
acquiring a sorting result by sorting multiple face images in the cache queue; and
acquiring the target face image for face recognition according to the sorting result.

19. The electronic equipment of claim 12, wherein the second face parameter comprises at least one of a face image sharpness, a face image brightness, or a face image pixel number.

20. A non-transitory computer-readable storage medium, having stored thereon computer program instructions which, when executed by a processor, implement:
acquiring, by filtering an image frame sequence, a face image frame sequence of which a first face parameter meets a preset condition;
determining a second face parameter of each face image in the face image frame sequence;
determining a quality score of the each face image in the face image frame sequence according to the first face parameter and the second face parameter of the each face image in the face image frame sequence; and
acquiring a target face image for face recognition according to the quality score of the each face image in the face image frame sequence.
